(19) United States
(12) Patent Application Publication
(10) Pub. No.: US 2023/0342817 A1
(43) Pub. Date: Oct. 26, 2023

(54) SYSTEMS AND METHODS FOR IMPLEMENTATION AND USE OF AN IDENTITY GRAPH

(71) Applicant: JPMORGAN CHASE BANK, N.A., New York, NY (US)

(72) Inventors: Priyank BHATIA, Jersey City, NJ (US); David PINTO-CARPENTER, Brooklyn, NY (US); Shawn W. BEATTIE, Middletown, DE (US); Chris C. TAYLOR, Windermere, FL (US)

(21) Appl. No.: 18/307,421

(22) Filed: Apr. 26, 2023

Related U.S. Application Data
(60) Provisional application No. 63/363,605, filed on Apr. 26, 2022.

(51) Int. Cl. G06Q 40/03; G06Q 30/0251

(52) U.S. Cl. CPC G06Q 30/0271; G06Q 40/03

(57) ABSTRACT

A method may include: receiving a third-party customer identifier for a customer and a request for offers to present to the customer; retrieving an integrated identity provider identifier associated with the third-party customer identifier in an anonymous graph maintained by the identity graph computer program; determining that a known customer identifier associated with the integrated identity provider identifier is present in a known graph maintained by the identity graph computer program, wherein the known graph stores entries comprising personal identifiable information for known customers, and the anonymous graph stores anonymized entries corresponding to the entries in the known graph; retrieving a known customer identifier for the integrated identity provider identifier from the known graph; providing the known customer identifier to a hosted bureau data computer program, wherein the hosted bureau data computer program returns an offer for which the known customer identifier is qualified; and returning the offer.

### RELATED APPLICATIONS

This application claims priority to, and the benefit of, U.S. Provisional Pat. Application Ser. No. 63/363,605, filed Apr. 26, 2022, the disclosure of which is hereby incorporated, by reference, in its entirety.

### BACKGROUND OF THE INVENTION

### 1. Field of the Invention

Embodiments generally relate to systems and methods for implementation and use of an identity graph.

### 2. Description of the Related Art

Organizations seek to improve access to, and the quality of, data that is used to deliver better customer experiences, offers, communications, and marketing. This generally requires a customer to be logged in and authenticated to the organization.

### SUMMARY OF THE INVENTION

Systems and methods for implementation and use of an identity graph are disclosed. In one embodiment, a method for pre-screening offers may include: (1) receiving, at an identity graph computer program, a third-party customer identifier for a customer and a request for offers to present to the customer from a requester computer program; (2) retrieving, by the identity graph computer program, an integrated identity provider identifier associated with the third-party customer identifier in an anonymous graph maintained by the identity graph computer program; (3) determining, by the identity graph computer program, that a known customer identifier associated with the integrated identity provider identifier is present in a known graph maintained by the identity graph computer program, wherein the known graph stores entries comprising personal identifiable information for known customers, and the anonymous graph stores anonymized entries corresponding to the entries in the known graph; (4) retrieving, by the identity graph computer program, a known customer identifier for the integrated identity provider identifier from the known graph; (5) providing, by the identity graph computer program, the known customer identifier to a hosted bureau data computer program, wherein the hosted bureau data computer program returns an offer for which the known customer identifier is qualified; and (6) returning, by the identity graph computer program, the offer to the requester computer program, wherein the requester computer program is configured to present the offer to the customer.

In one embodiment, the identity graph computer program further receives a requester customer identifier with the request for offers, and the identity graph computer program returns the requester customer identifier to the requester computer program with the offer.

In one embodiment, the hosted bureau data computer program comprises credit information for a plurality of known customers in the known graph.

In one embodiment, the anonymous graph comprises a mapping among third-party customer identifiers, integrated identity provider identifiers, and known customer identifiers.

In one embodiment, the requester computer program comprises a merchant, a website, or a social media site.

In one embodiment, the known graph and the anonymous graph are hosted by an entity of which the known customer is a customer.

In one embodiment, the integrated identity provider identifier is provided by a third party.

According to another embodiment, a method for providing information to pre-fill applications may include: (1) receiving, at an identity graph computer program, a third-party customer identifier for a customer and a request for pre-fill customer information for an application for a product for a customer from a requester computer program; (2) retrieving, by the identity graph computer program, an integrated identity provider identifier associated with the third-party customer identifier in an anonymous graph maintained by the identity graph computer program; (3) determining, by the identity graph computer program, that a known customer identifier associated with the integrated identity provider identifier is present in a known graph maintained by the identity graph computer program, wherein the known graph stores entries comprising known customer information comprising personal identifiable information for known customers, and the anonymous graph stores anonymized entries corresponding to the entries in the known graph; (4) retrieving, by the identity graph computer program, a known customer identifier for the integrated identity provider identifier from the known graph; (5) retrieving, by the identity graph computer program, the known customer information for the known customer identifier from the known graph; (6) pre-filing, by the identity graph computer program, the application with the known customer information; and (7) returning, by the identity graph computer program, the application comprising pre-fill customer information to the requester computer program, wherein the requester computer program is configured to present the application comprising the pre-fill customer information to the customer.

In one embodiment, the identity graph computer program further receives a requester customer identifier with the request for pre-fill customer information, and the identity graph computer program returns the requester customer identifier to the requester computer program with the application comprising the pre-fill customer information.

In one embodiment, the known customer information comprises a name and address for the customer.

In one embodiment, the anonymous graph comprises a mapping among third-party customer identifiers, integrated identity provider identifiers, and known customer identifiers.

In one embodiment, the requester computer program comprises a merchant, a website, or a social media site.

In one embodiment, the known graph and the anonymous graph are hosted by an entity of which the known customer is a customer.

According to another embodiment, a method for identifying behavior-based offers may include: (1) receiving, at an identity graph computer program, a third-party customer identifier for a customer and a request for a behavior-based offer for a customer from a requester computer program; (2) retrieving, by the identity graph computer program, an integrated identity provider identifier associated with the third-party customer identifier in an anonymous graph maintained by the identity graph computer program; (3) determining, by the identity graph computer program, that a known customer identifier associated with the integrated identity provider identifier is present in a known graph maintained by the identity graph computer program, wherein the known graph stores entries comprising known customer information comprising personal identifiable information for known customers, and the anonymous graph stores anonymized entries corresponding to the entries in the known graph; (4) retrieving, by the identity graph computer program, a known customer identifier for the integrated identity provider identifier from the known graph; (5) providing, by the identity graph computer program, the known customer identifier to a behavior-based offer platform, wherein the behavior-based offer platform returns the behavior-based offer for which the known customer identifier is eligible, wherein the behavior-based offer is identified based on customer behavior activity received by the behavior-based offer platform from a web-based channel or a mobile based channels; and (6) returning, by the identity graph computer program, the behavior-based offer to the requester computer program, wherein the requester computer program is configured to present the behavior-based offer to the customer.

In one embodiment, the method may also include providing, by the identity graph computer program, the behavior-based offer to a hosted bureau data computer program, wherein the hosted bureau data computer program returns an offer for which the known customer identifier is qualified before returning the behavior-based offer to the requester computer program.

In one embodiment, the hosted bureau data computer program comprises credit information for a plurality of known customers in the known graph.

In one embodiment, the requester computer program comprises a merchant, a website, or a social media site.

In one embodiment, the anonymous graph comprises a mapping among third-party customer identifiers, integrated identity provider identifiers, and known customer identifiers.

In one embodiment, the requester computer program comprises a merchant, a website, or a social media site.

In one embodiment, the known graph and the anonymous graph are hosted by an entity of which the known customer is a customer.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for implementation and use of an identity graph according to an embodiment;

FIG. 2 depicts a method for ingesting data into an anonymous graph according to an embodiment;

FIG. 3 depicts a method for implementation and use of an identity graph according to an embodiment;

FIG. 4 depicts a method for pre-screening offers according to an embodiment;

FIG. 5 depicts a method for providing information to pre-fill applications according to an embodiment;

FIG. 6 depicts a method for identifying behavior-based offers according to an embodiment; and

FIG. 7 depicts an exemplary computing system for implementing aspects of the present disclosure.

### DETAILED DESCRIPTION OF PREFERRED EMBODIMENTS

Embodiments are directed to systems and methods for implementation and use of an identity graph. For example, embodiments may recognize consumers that are unauthenticated and either on or off of an organization property, such as a website or application.

Embodiments may generate and use identity graphs and a network of recognition partners to recognize prospects and existing customers in non-authenticated digital experiences (both within and external to the organization) at scale, enabling the targeting of personalized offers and experiences, in owned, partner, and paid media channels. The use of a customer data platform and the identity graph enables the orchestration of campaigns across channels - thus, omni-channel marketing at scale.

Embodiments may provide at least some of the following:
Omnichannel offer targeting: With expanded recognition across partner sites, owned sites and paid channels, embodiments may provide consistent personalized offers to consumers across un-authenticated channels. These offers may include pre-screened offers, high value offers, and enhanced recommendations based on consumer’s identity.
Paid media cookie-less solution.
Improved data security: Instead of sending raw customer data to third parties, embodiments may link proprietary identifiers and host them in an identity graph. Thus, requisite data may be provided to third parties without directly exposing personal information, thereby reducing exposure and risk of breach.
Reduced vendor dependency: The identity graph reduces complexity, improves transparency, and enables new capabilities to be built on top of the identity graph as needed.

Embodiments provide an environment that enables customer data to be combined with third-party data sources and exchanged with trusted partners, in a privacy safe, compliant manner. Embodiments enable an organization to house profiles for both customers and prospects in a common environment.

In embodiments, customer data may go through a series of hygiene and de-identification steps enabling profile linkage to third-party data sources such as partners and credit bureaus. Identifiers may be used to deliver offers and marketing messages outside of the organization. Unknown profiles -consumers with whom the organization does not have an existing relationship -may also be housed within the identity graph.

Identity recognition providers may send third-party identifiers mapped to the organization, to customers, or to prospect data. This may occur through various integrations, such as offer APIs, batch files, etc.

In embodiments, an identity graph may include a known graph and an anonymous graph. Customer information (e.g., PII) in the known graph may be de-identified for the anonymous graph, and anonymous data may be identified for the known graph. A third-party data linkage may be used to link the anonymous graph to third parties.

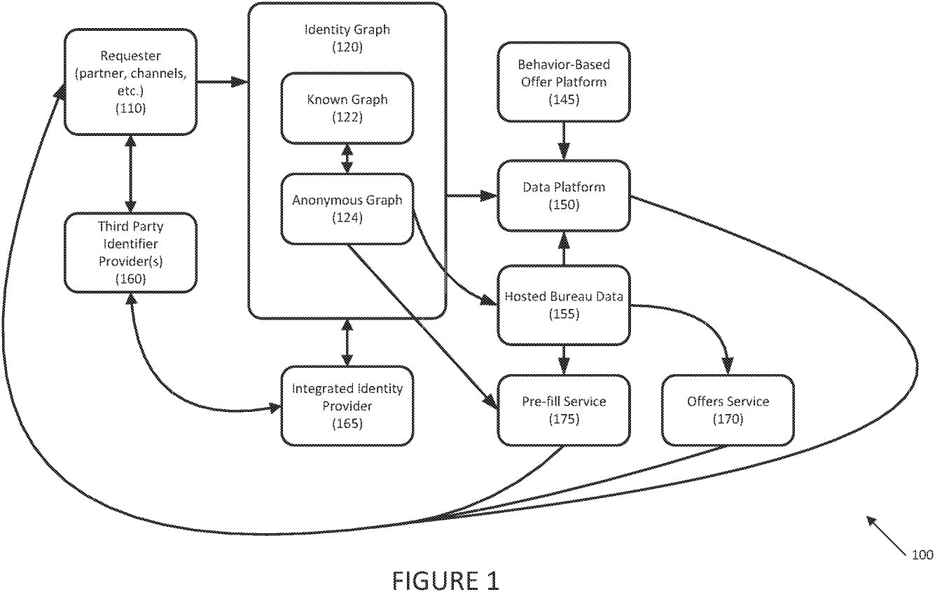

Referring to FIG. 1, a system for implementation and use of an identity graph is disclosed according to an embodiment. System 100 may include one or more requesters 110, which may include merchants, partners, websites, social media sites, paid channels, etc. Requesters 110 may interface with identity graph 120, which may include known graph 122 and anonymous graph 124. Known graph 122 may include personal identifiable information, or PII, about individuals that may be known customers of the entity maintaining the identity graph. Examples of such an entity include financial institutions, financial technology (FinTech) entities, etc.

Examples of PII may include name, address, phone number, email, etc. for individuals. Each individual may have a record that may include the individual’s PII, as well as a common customer identifier that may be used to link the individual’s known graph record to the individual’s anonymous graph customer record.

Each known customer may be associated with a known customer identifier, which may be associated with the PII for the known customers and stored in known graph 122.

To convert a known individual record to an anonymous individual record, the known individual record may undergo a de-identification process in which PII is removed, obscured, altered, etc. In one embodiment, PII may also be related with genericized data. Conversely, an anonymous individual record may undergo an identification process, where the common identifier may be used to identify the individual.

Identity graph 120 may expose one or more application programming interfaces (APIs), such as an offers API to expose offer services, and a pre-fill API to expose pre-fill services, to partner channels.

System 100 may further include integrated identity provider 165, which may assign each customer an integrated identity provider identity, or “IIP ID,” and maintain a regularly refreshed sync of third-party identifiers, including IIP identifiers. Integrated identity provider 165 may collect known customer identifiers for customers of an institution and may send the IIP identifier for each known customer identifier to the identity graph. The IIP identifier may be stored within the anonymous graph that may be mapped to, for example, hashed known customer identifiers and other third-party identifiers that may be provided by third-party identifier providers 160. Integrated identity provider 165 may interface with other third parties and may associate third-party identifiers with the IIP identifier and the known customer identifier.

System 100 may include behavior-based offer platform 145 that may receive behavioral data from, for example, web-based channels, mobile based channels, etc. Using the behavioral data, behavior-based offer platform 145 may link visit information with any known identifier and/or a bureau identifier linked to hosted bureau data 155 and may return an offer to present to requester 110.

Data platform 150 may interface with identity graph 120, behavior-based offer platform 145, and hosted bureau data 155, and may identify offers to present to requesters 110.

Hosted bureau data 155 may include data provided by a credit bureau or similar entity. Hosted bureau data 155 may include data for customers in known graph 122, as well as other customers who may be identified with an IIP identifier and/or a bureau identifier.

Offers service 170 may receive hosted bureau data 155 and may return offers to requesters 110. Pre-fill service 175 may add an individual’s known information (e.g., email, address, phone number, etc.) to an application, such as credit card application, so the individual does not have to manually enter the information, and return the pre-filled application to requesters 110.

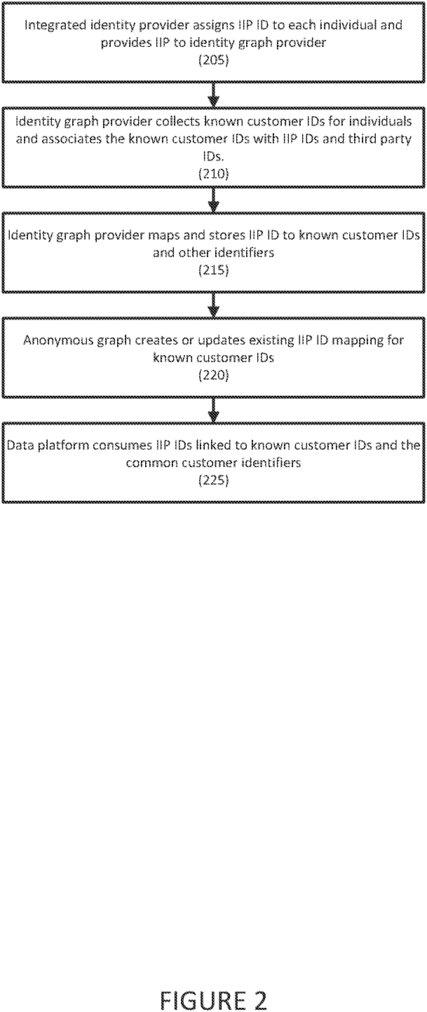

Referring to FIG. 2, a method for ingesting data into an anonymous graph is provided according to an embodiment.

In step 205, an integrated identity provider computer program may assign an integrated identity provider identifier to individuals as they are identified. In one embodiment, the IIP identifier may be any suitable identifier that may be unique to the individual.

In step 210, the identity graph provider computer program may collect known customer identifiers for individuals and may associate the collected known customer identifier with one of the IIP identifiers. The known customer identifier may be collected from, for example, a known graph with PII, an anonymous graph along with other third-party identifiers, on-site using a behavior-based offer platform cookie, passed with behavioral data for authenticated customer sessions, from a data platform to link customer interactions and marketing execution platforms, etc.

In step 215, the identity graph provider computer program may store the IIP ID in an anonymous graph, and may map the IIP identifiers to the collected known customer identifiers. It may maintain a connection with an anonymous graph for an identity graph provider so that relationships among the IIP identifiers the known customer identifiers, and any other third-party identifiers are kept current.

In step 220, the anonymous graph may create or update an existing IIP identifier mapping in the anonymous graph. In one embodiment, the anonymous graph may be located within a customer source of record to facilitate exchanges with the data platform, expose APIs (e.g., offer APIs, pre-fill APIs, etc.), etc.

In step 225, the data platform may also consume the IIP identifiers linked to the known customer identifiers and common customer identifiers that may be used for audience management and omni-channel orchestration.

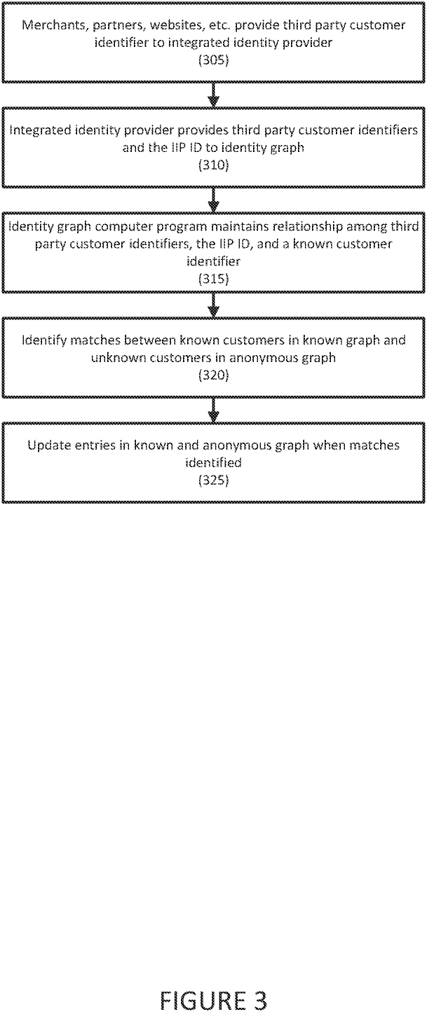

Referring to FIG. 3, a method for implementation and use of an identity graph is disclosed according to an embodiment.

In step 305, merchants, partners, websites, social media sites, etc. may provide third-party customer identifiers to an integrated identity provider. The integrated identity provider may receive the third-party customer identifiers and associate them with the IIP identifier.

The merchants, partners, websites, social media sites, etc. may also provide identifying information they may have for their customers or individuals, such as name, address, phone number, email address, IP address, device identifier, etc.

In step 310, the integrated identity provider may provide the third-party customer identifiers and the IIP identifier to the identity graph. It may also provide any available identifying information associated with the third-party customer identifiers and the IIP identifiers.

In step 315, an identity graph computer program may maintain a relationship among the third-party customer identifiers, the IIP identifier, and a known customer identifier for customers in the known identity graph as applicable.

In step 320, the identity graph computer program may identify matches between known customers in known graph and unknown customers in anonymous graph using the available identifying information.

In step 325, the identity graph computer program may update entries in the known graph and the anonymous graph when matches are identified. In one embodiment, a matching confidence level may be used to determine when a match is identified. The matching confidence level may be set manually, may be based on the uniqueness of the fields (e.g., a phone number match may have a higher confidence than a name match), may be based on machine learning, etc.

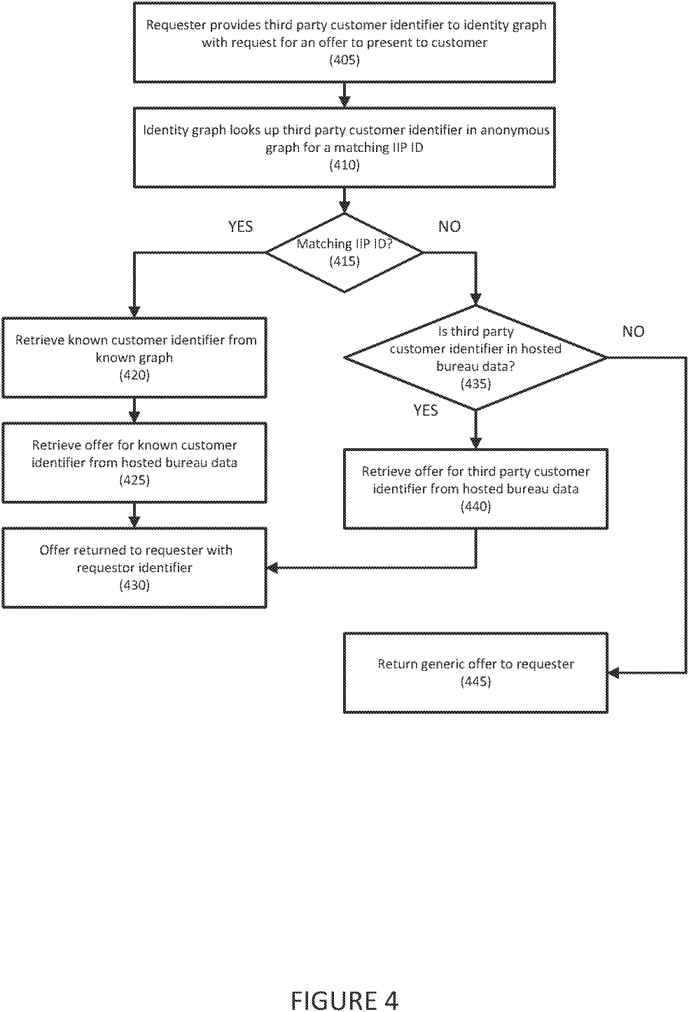

Referring to FIG. 4, a method for pre-screening offers is provided according to an embodiment.

In step 405, a requester, such as a merchant, a partner, a website, a social media site, etc., may provide their third-party customer identifier to an identity graph computer program with a request for an offer to present to customer. The requester may also provide a requester customer identifier, which may be the requester’s identifier for the customer. In some circumstances, the requester customer identifier and the third-party customer identifier may be the same.

In step 410, the identity graph computer program may look up the third-party customer identifier in an anonymous graph for an IIP identifier associated with the third-party customer identifier.

In step 415, the identity graph computer program may determine whether there is a matching IIP identifier in the known graph. If there is, in step 420, the identity graph computer program may retrieve the known customer identifier from the known graph that is associated with the IIP identifier.

In step 425, the identity graph computer program may provide the known customer identifier to the hosted bureau data, which may return one or more offers for which the known customer identifier is qualified.

In step 430, the identity graph computer program may return the one or more offers to the requester with the requester customer identifier and/or the third-party customer identifier.

If, in step 415, there is not a matching IIP in the known graph, in step 435, the identity graph computer program may determine if the third-party customer identifier is present in the hosted bureau data. If it is, in step 440, the hosted bureau data may return one or more offers for which the third-party customer identifier is qualified for, and in step 430, may return the one or more offers to the requester with the requester customer identifier and/or the third-party customer identifier.

If, in step 435, the third-party customer identifier is not present in the hosted bureau data, in step 445, the identity graph computer program may return a generic offer to the requester.

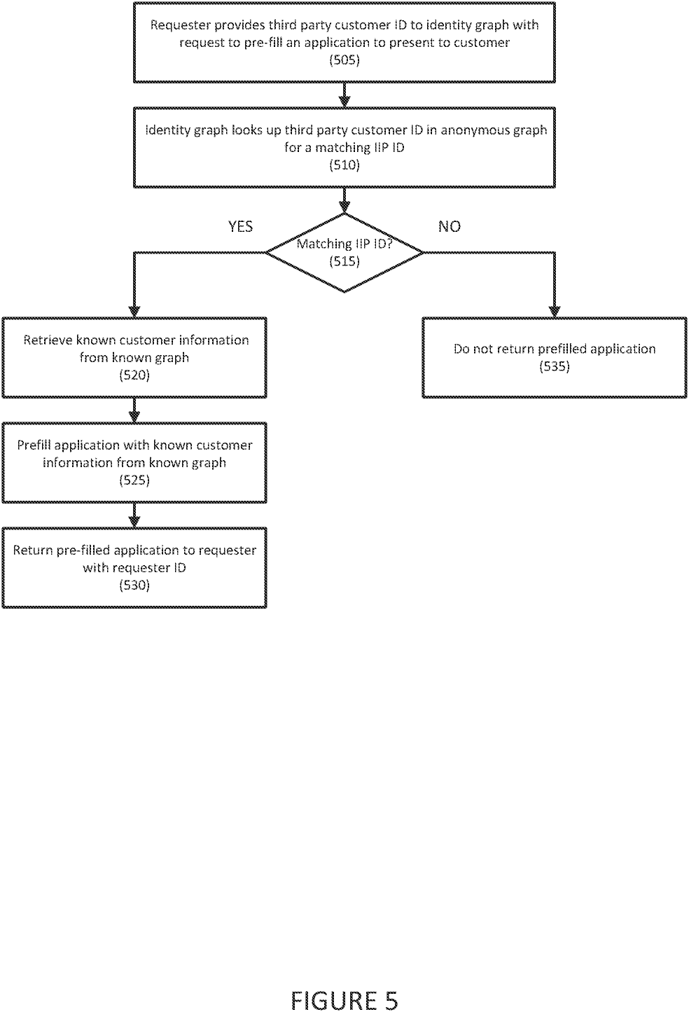

Referring to FIG. 5, a method for providing information to pre-fill applications is provided according to an embodiment.

In step 505, a requester, such as a merchant, a partner, a website, a social media site, etc., may provide their third-party customer identifier to an identity graph computer program with a request to pre-fill an application to present to customer. The requester may also provide a requester customer identifier, which may be the requester’s identifier for the customer. In some circumstances, the requester customer identifier and the third-party customer identifier may be the same.

In step 510, the identity graph computer program may look up the third-party customer identifier in an anonymous graph for an IIP identifier associated with the third-party customer identifier.

In step 515, the identity graph computer program may determine whether there is a matching IIP identifier in the known graph. If there is, in step 520, the identity graph computer program may retrieve the known customer information from the known graph that is associated with the IIP identifier.

In step 525, the identity graph computer program may prefill the application with known customer information retrieved from the known graph, and in step 530, may return the pre-filled application to the requester with requester customer identifier and/or the third-party customer identifier.

If, in step 515, there is not a match, indicating that the customer is not a known customer, in step 535, the identity graph computer program may return the application without prefills.

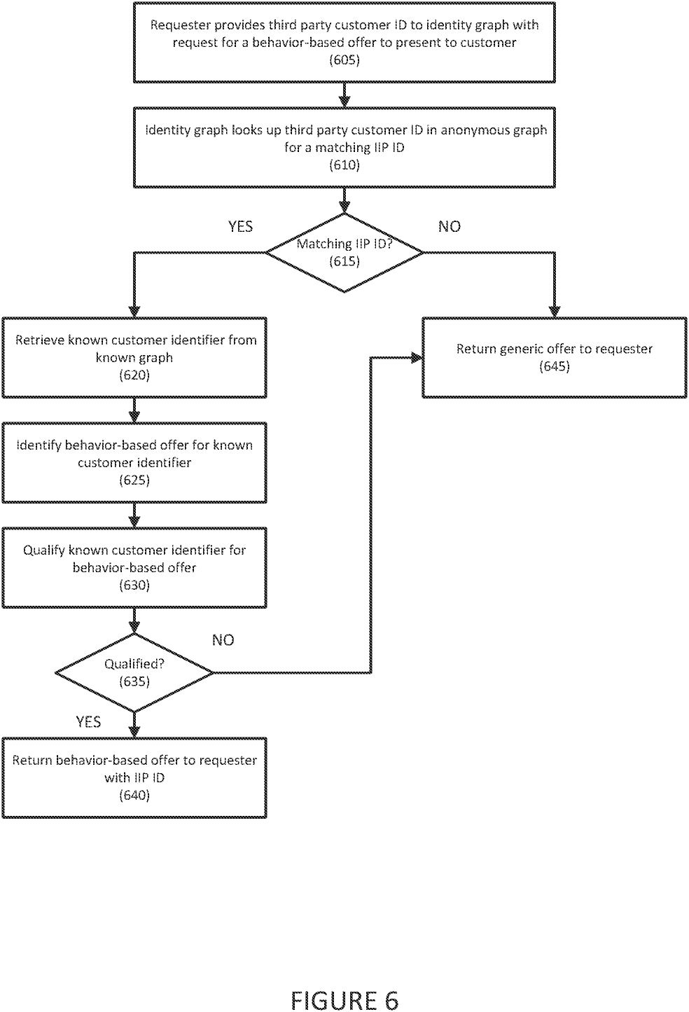

Referring to FIG. 6, a method for identifying behavior-based offers is provided according to an embodiment.

In step 605, a requester, such as a merchant, a partner, a website, a social media site, etc., may provide a requester customer identifier and/or a third-party customer identifier to an identity graph computer program with a request for a behavior-based offer to present to customer.

In step 610, the identity graph computer program may look up the requester customer identifier and/or the third-party customer identifier in an anonymous graph for an IIP identifier associated with the third-party customer identifier.

In step 615, the identity graph computer program may determine whether there is a matching IIP identifier in the known graph. If there is, in step 620, the identity graph computer program may retrieve the known customer identifier from the known graph.

In step 625, the identity graph computer program may provide the known customer identifier to a behavior-based offer platform, which may return one or more behavior-based offers for the known customer identifier.

In step 630, the identity graph computer program may qualify known customer identifier for behavior-based offers using the hosted bureau data for the known customer identifier.

If, in step 635, the customer is qualified, in step 640, the identity graph computer program may return the behavior-based offer to the requester with the requester ID.

If, in step 635, the customer is not qualified for the behavior-based offer, in step 645, the identity graph computer program may return a generic offer to the requester.

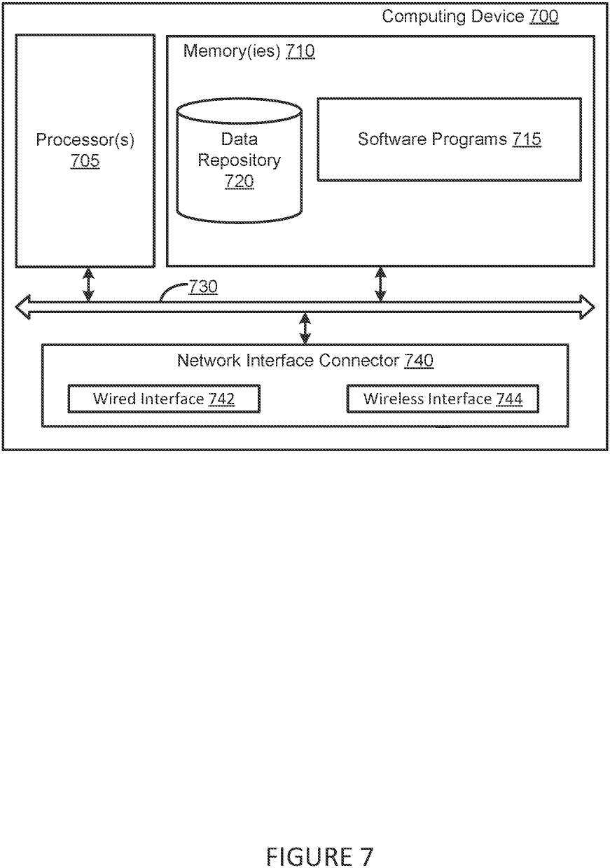

FIG. 7 depicts an exemplary computing system for implementing aspects of the present disclosure. FIG. 7 depicts exemplary computing device 700. Computing device 700 may represent the system components described herein. Computing device 700 may include processor 705 that may be coupled to memory 710. Memory 710 may include volatile memory. Processor 705 may execute computer-executable program code stored in memory 710, such as software programs 715. Software programs 715 may include one or more of the logical steps disclosed herein as a programmatic instruction, which may be executed by processor 705. Memory 710 may also include data repository 720, which may be nonvolatile memory for data persistence. Processor 705 and memory 710 may be coupled by bus 730. Bus 730 may also be coupled to one or more network interface connectors 740, such as wired network interface 742 or wireless network interface 744. Computing device 700 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for pre-screening offers, comprising:
receiving, at an identity graph computer program, a third-party customer identifier for a customer and a request for offers to present to the customer from a requester computer program;
retrieving, by the identity graph computer program, an integrated identity provider identifier associated with the third-party customer identifier in an anonymous graph maintained by the identity graph computer program;
determining, by the identity graph computer program, that a known customer identifier associated with the integrated identity provider identifier is present in a known graph maintained by the identity graph computer program, wherein the known graph stores entries comprising personal identifiable information for known customers, and the anonymous graph stores anonymized entries corresponding to the entries in the known graph;
retrieving, by the identity graph computer program, a known customer identifier for the integrated identity provider identifier from the known graph;
providing, by the identity graph computer program, the known customer identifier to a hosted bureau data computer program, wherein the hosted bureau data computer program returns an offer for which the known customer identifier is qualified; and
returning, by the identity graph computer program, the offer to the requester computer program, wherein the requester computer program is configured to present the offer to the customer.

2. The method of claim 1, wherein the identity graph computer program further receives a requester customer identifier with the request for offers, and the identity graph computer program returns the requester customer identifier to the requester computer program with the offer.

3. The method of claim 1, wherein the hosted bureau data computer program comprises credit information for a plurality of known customers in the known graph.

4. The method of claim 1, wherein the anonymous graph comprises a mapping among third-party customer identifiers, integrated identity provider identifiers, and known customer identifiers.

5. The method of claim 1, wherein the requester computer program comprises a merchant, a website, or a social media site.

6. The method of claim 1, wherein the known graph and the anonymous graph are hosted by an entity of which the known customer is a customer.

7. The method of claim 1, wherein the integrated identity provider identifier is provided by a third party.

8. A method for providing information to pre-fill applications, comprising:
receiving, at an identity graph computer program, a third-party customer identifier for a customer and a request for pre-fill customer information for an application for a product for a customer from a requester computer program;
retrieving, by the identity graph computer program, an integrated identity provider identifier associated with the third-party customer identifier in an anonymous graph maintained by the identity graph computer program;
determining, by the identity graph computer program, that a known customer identifier associated with the integrated identity provider identifier is present in a known graph maintained by the identity graph computer program, wherein the known graph stores entries comprising known customer information comprising personal identifiable information for known customers, and the anonymous graph stores anonymized entries corresponding to the entries in the known graph;
retrieving, by the identity graph computer program, a known customer identifier for the integrated identity provider identifier from the known graph;
retrieving, by the identity graph computer program, the known customer information for the known customer identifier from the known graph;
pre-filing, by the identity graph computer program, the application with the known customer information; and
returning, by the identity graph computer program, the application comprising pre-fill customer information to the requester computer program, wherein the requester computer program is configured to present the application comprising the pre-fill customer information to the customer.

9. The method of claim 8, wherein the identity graph computer program further receives a requester customer identifier with the request for pre-fill customer information, and the identity graph computer program returns the requester customer identifier to the requester computer program with the application comprising the pre-fill customer information.

10. The method of claim 8, wherein the known customer information comprises a name and address for the customer.

11. The method of claim 8, wherein the anonymous graph comprises a mapping among third-party customer identifiers, integrated identity provider identifiers, and known customer identifiers.

12. The method of claim 8, wherein the requester computer program comprises a merchant, a website, or a social media site.

13. The method of claim 8, wherein the known graph and the anonymous graph are hosted by an entity of which the known customer is a customer.

14. A method for identifying behavior-based offers, comprising:
receiving, at an identity graph computer program, a third-party customer identifier for a customer and a request for a behavior-based offer for a customer from a requester computer program;
retrieving, by the identity graph computer program, an integrated identity provider identifier associated with the third-party customer identifier in an anonymous graph maintained by the identity graph computer program;
determining, by the identity graph computer program, that a known customer identifier associated with the integrated identity provider identifier is present in a known graph maintained by the identity graph computer program, wherein the known graph stores entries comprising known customer information comprising personal identifiable information for known customers, and the anonymous graph stores anonymized entries corresponding to the entries in the known graph;
retrieving, by the identity graph computer program, a known customer identifier for the integrated identity provider identifier from the known graph;
providing, by the identity graph computer program, the known customer identifier to a behavior-based offer platform, wherein the behavior-based offer platform returns the behavior-based offer for which the known customer identifier is eligible, wherein the behavior-based offer is identified based on customer behavior activity received by the behavior-based offer platform from a web-based channel or a mobile based channels; and
returning, by the identity graph computer program, the behavior-based offer to the requester computer program, wherein the requester computer program is configured to present the behavior-based offer to the customer.

15. The method of claim 14, further comprising:
providing, by the identity graph computer program, the behavior-based offer to a hosted bureau data computer program, wherein the hosted bureau data computer program returns an offer for which the known customer identifier is qualified before returning the behavior-based offer to the requester computer program.

16. The method of claim 15, wherein the hosted bureau data computer program comprises credit information for a plurality of known customers in the known graph.

17. The method of claim 14, wherein the requester computer program comprises a merchant, a website, or a social media site.

18. The method of claim 14, wherein the anonymous graph comprises a mapping among third-party customer identifiers, integrated identity provider identifiers, and known customer identifiers.

19. The method of claim 14, wherein the requester computer program comprises a merchant, a website, or a social media site.

20. The method of claim 14, wherein the known graph and the anonymous graph are hosted by an entity of which the known customer is a customer.
